(19) United States
(12) Patent Application Publication
(10) Pub. No.: US 2007/0259614 A1
(43) Pub. Date: Nov. 8, 2007

(54) Actuation system for controlling movement of doors

(75) Inventors: Donald D. Barnhart, West Bloomfield, MI (US); Quincy R. Burton, Farmington Hills, MI (US); Daniel G. Karch, Novi, MI (US)

Correspondence Address: MESCHKOW & GRESHAM, P.L.C., 5727 NORTH SEVENTH STREET, SUITE 409, PHOENIX, AZ, 85014, US

(73) Assignee: CalsonicKansei North America, Inc.

(21) Appl. No.: 11/430,748

(22) Filed: May 8, 2006

(51) Int. Cl. B60S 1/54

(52) U.S. Cl. 454/121

(57) ABSTRACT

An actuation system (44) for controlling a first door (38) and a second door (40) includes a first actuator (72) having a first interior passage (74) and a second actuator (76) in line with the first actuator (72). A first shaft (82) extends from the first actuator (72) and has a second interior passage (86). A second shaft (88) extends from the second actuator (76) and is directed through the first and second interior passages (74, 86) to exit from the first shaft (82). The first shaft (82) is in communication with the first door (38), and the first actuator (72) drives the first shaft (82) to move the first door (38). The second shaft (88) is in communication with the second door (40), and the second actuator (76) drives the second shaft (88) to move the second door (40) independent from movement of the first door (38).

### TECHNICAL FIELD OF THE INVENTION

The present invention relates to the field of air handling systems. More specifically, the present invention relates to an actuation system for controlling movement of doors in an air handling system for a vehicle.

### BACKGROUND OF THE INVENTION

Vehicles, such as automobiles, vans, trucks, and the like, are typically provided with an air handling system, commonly referred to as a heating, ventilation, and air conditioning (HVAC) system. HVAC systems provide temperature control via selection between heating, ventilation, and cooling modes, as well as selection of various distribution paths within the vehicle, such as toward the front seat occupants, toward the floor, toward the windshield, and the like.

In a conventional vehicle air handling system, a heater core is mounted in an air duct downstream of an evaporator core. Engine coolant is circulated through the heater core to heat the air. For air conditioning, refrigerant is circulated through the evaporator core. Control of the air temperature is obtained by controlling the flow of air from the evaporator core to the heater core. For maximum cooling, all of the air flow from the evaporator core bypasses the heater core and travels directly to the passenger compartment. Similarly, for maximum heating, all of the air flow from an inactive evaporator core passes through the heater core, where the air is heated before traveling to the passenger compartment. Intermediate these two extremes, bypass flow and flow through the heater core mix to provide air flow to the passenger compartment at an intermediate temperature.

To increase passenger comfort, recent trends have led to multiple, independently selectable temperature zones, referred to as multi-zone temperature control. Individualized temperature control is accomplished by dividing the occupant compartment into zones, the temperature of each zone being controlled by a separate user manipulatable lever or actuator to affect movement of individual blend doors. For example, a dual zone system may be divided into a front driver-side zone and a front passenger-side zone each having independent ducting and temperature control. Similarly, a tri-zone system includes independent ducting and temperature control of three zones, such as front driver-side, front passenger-side, and the rear passenger portion of the vehicle. A quad-zone system includes independent ducting and temperature control of four zones, such as front driver-side, front passenger-side, rear right-side, and a rear left-side of the vehicle.

Many components of the HVAC system, such as the heater core, the evaporator core, ducting, actuators, and the like are located in or near the vehicle instrument panel. Physical space in the vehicle instrument panel has historically been limited, and has become even more limited as new electronic devices and convenience features have been added to the instrument panel.

Typical multi-zone HVAC systems employ a common HVAC assembly that includes a cold or bypass air supply duct that branches to a cold air inlet for each independent zone duct, and a hot air supply duct that branches to a hot air inlet for each independent zone duct. The zone duct is separated from the cold and hot inlets by a blend door that is moveable by an actuator to provide cold, hot, or a blend of hot and cold air into the corresponding zone duct. These additional components such as independent ducting, multiple blend doors, and so forth that are needed to achieve multi-zone temperature control further burdens the already limited physical space in the vehicle.

In a multi-zone HVAC system, each blend door for each zone has a separate actuator. These multiple actuators can be costly and can cause problems in terms of space and access for installation and repair. In one prior art system for a dual-zone configuration, the two actuators are mounted beside one another, with one actuator mounted in line with its corresponding shaft and the other actuator mounted offset from its corresponding shaft. A link mechanism is used to connect this offset actuator with its corresponding shaft. Unfortunately, this link mechanism adds cost and complexity to the system and results in hysteresis, or delayed response of door movement, and inaccuracies of the door position. Inaccurate door movement or delayed door movement directly affects temperature dispersion and air distribution of the HVAC system, thus deteriorating its performance.

Accordingly, what is needed is an actuation system for a door assembly in a multi-zone air handling system that utilizes minimal physical space, and functions with precision to achieve the desired mixing of cooled air, heated air, or a blend of heated and cooled air.

### SUMMARY OF THE INVENTION

Accordingly, it is an advantage of the present invention that a system is provided for controlling the movement of doors in an air handling system to distribute separate temperature airstreams to multiple zones within a vehicle.

It is another advantage of the present invention that a system for controlling movement is provided that functions accurately to achieve a desired mixing of cooled air, heated air, or a blend of heated and cooled air in each of the zones.

Another advantage of the present invention is that a system is provided for controlling door movement that efficiently utilizes the limited physical space in the vehicle.

Yet another advantage of the present invention is that a system is provided that has a simplified design that is cost effectively manufactured and installed within a vehicle.

The above and other advantages of the present invention are carried out in one form by a system for controlling a first door and a second door. The system includes a first actuator having a first interior passage and a second actuator arranged in line with the first actuator. A first shaft extends from the first actuator and has a second interior passage, the first shaft being configured for communication with the first door, and the first actuator driving the first shaft to cause movement of the first door. A second shaft extends from the second actuator and is directed through the first and second interior passages to exit from an end of the first shaft. The second shaft is configured for communication with the second door, and the second actuator drives the second shaft to cause movement of the second door.

The above and other advantages of the present invention are carried out in another form by a door assembly for use in a heating, ventilation, and air conditioning (HVAC) system of a vehicle. The door assembly includes a first door for controlling airflow through a first opening of the HVAC system depending on a position of the first door, and a second door for controlling airflow through a second opening of the HVAC system depending on a position of the second door. The door assembly further includes an actuation system for controlling movement of the first and second doors. The actuation system includes a first actuator having a first interior passage and a second actuator arranged in line with the first actuator. A first shaft extends from the first actuator and is in communication with the first door. The first shaft has a second interior passage, and the first actuator drives the first shaft to move the first door to control the airflow through the first opening. A second shaft extends from the second actuator and is directed through the first and second interior passages to exit from an end of the first shaft. The second shaft rotates independent from the first shaft within the first and second interior passages, and is in communication with the second door. The second actuator drives the second shaft to move the second door to control the airflow through the second opening.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a vehicle into which an air handling system is incorporated;

FIG. 2 shows a partially exploded perspective view of a door assembly for the air handling system of FIG. 1 in accordance with a preferred embodiment of the present invention;

FIG. 3 shows an exploded side view of an actuation system of the door assembly of FIG. 2;

FIG. 4 shows a block diagram of a portion of the air handling system demonstrating airflow via the door assembly of FIG. 2 to each zone within the vehicle;

FIG. 5 shows a perspective view of a door assembly for a tri-zone air handling system in accordance with an alternative embodiment of the present invention; and

FIG. 6 shows a perspective view of a door assembly for a quad-zone air handling system in accordance with another alternative embodiment of the present invention.

### DETAILED DESCRIPTION OF THE PREFERRED EMBODIMENTS

The present invention entails an actuation system for controlling movement of at least two doors, commonly referred to as blend doors, in an air handling system of a vehicle. The actuation system and a door assembly incorporating the actuation system are particularly suitable for distributing separate temperature airstreams to multiple zones within the vehicle. However, the present invention need not be limited to such an application. Alternatively, the present invention may be incorporated within various systems in which the movement of aligned doors are separately controlled and physical space for such actuation systems is limited.

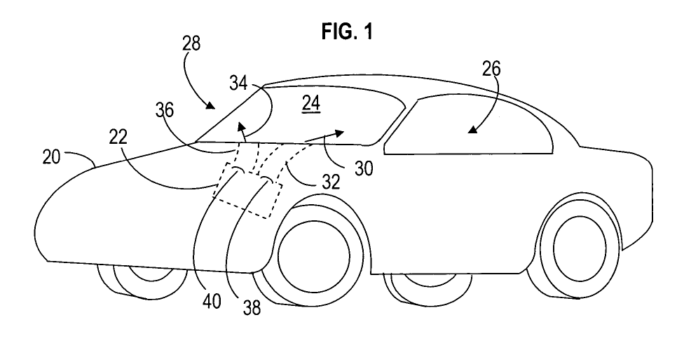

FIG. 1 shows a perspective view of a vehicle 20 into which an air handling system 22 (shown in ghost form) is incorporated. Air handling system 22 is a vehicle heating, ventilation, and air conditioning (HVAC) system that generally provides for climate control of an occupant compartment 24 of vehicle 20. HVAC system 22 provides multi-zone climate control for at least two zones, such as a front driver-side zone, referred to herein as first zone 26, and a front passenger-side zone, referred to herein as a second zone 28. More particularly, HVAC system 22 provides a first airflow 30, the temperature of which is controlled by an independent user control (not shown), to first zone 26 of occupant compartment 24 via a first zone duct 32. HVAC system 22 further provides a second airflow 34, the temperature of which is controlled by its corresponding independent user control (not shown), to second zone 28 of occupant compartment 24 via a second zone duct 36. The dual zone HVAC system 22 increases passenger comfort through the utilization of independently settable temperature zones.

HVAC system 22 can take a great variety of configurations and operational capabilities well known in the art and not critical to understanding the present invention. Hence, details of HVAC system 22 are not discussed herein for brevity. Rather, the present invention entails the control of a first door 38 that allows passage of first airflow 30 at a selected temperature setting into first zone 26. The present invention further entails the control of a second door 40, positioned beside first door 38, that allows passage of second airflow 34 at an independently selected temperature setting into front second zone 28.

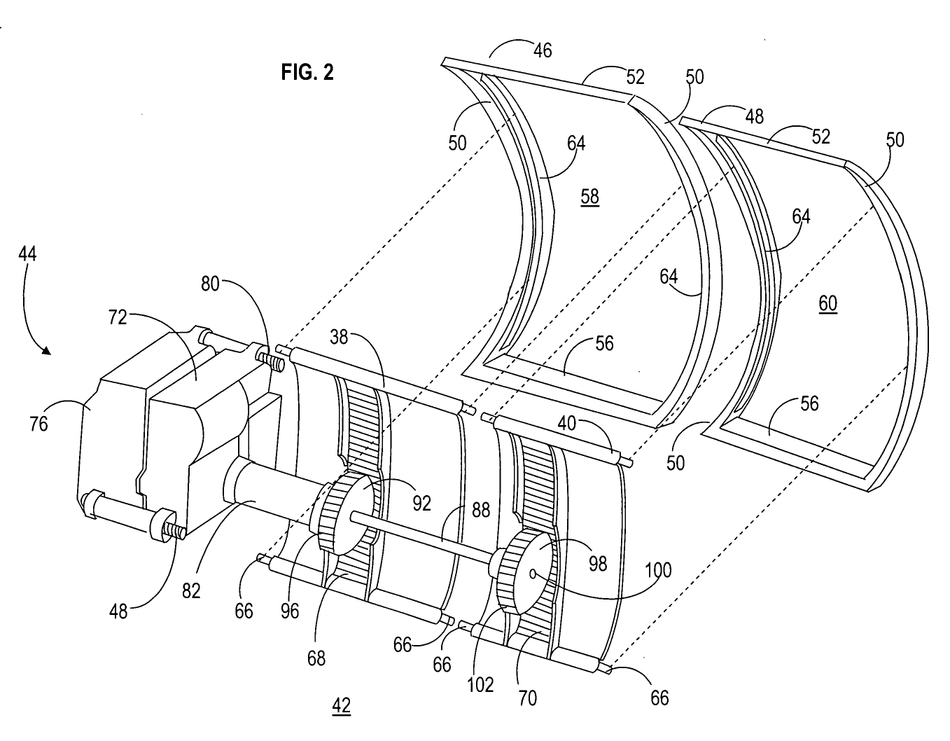

FIG. 2 shows a partially exploded perspective view of a door assembly 42 for use in HVAC system 22 (FIG. 1) in accordance with a preferred embodiment of the present invention. In particular, door assembly 42 is interposed between hot and cold air ducts (not shown) of HVAC system 22 and first and second zone ducts 32 and 36, respectively (FIG. 1). Thus, door assembly 42 controls hot and cold airflow from HVAC system 22 through first and second zone ducts 32 and 36 and into first zone 26 and second zone 28 of occupant compartment 24 (FIG. 1).

Door assembly 42 includes first door 38 and second door 40 each configured as arcuate members. Door assembly 42 further includes an actuation system 44 for controlling movement of first door 38 within a first frame 46 and second door 40 within a second frame 48 of HVAC system 22.

Each of first and second frames 46 and 48, respectively, includes side members 50, a top span 52, and a bottom span 56. A first opening 58 into first zone duct 32 (FIG. 1) is bounded by side members 50, top span 52, and bottom span 56 of first frame 46. Similarly, a second opening 60 into second zone duct 36 is bounded by side members 50, top span 52, and bottom span 56 of second frame 48. Side panels (not shown) may be interposed between first and second frames 46 and 48 to provide isolation for first door 38 in first frame 46 from second door 40 in second frame 48.

Side members 50 can include grooves 64 for slidably receiving corresponding spindles 66 on each of first and second doors 38 and 40, respectively. A first gear rack 68 is positioned on a concave surface of first door 38 and a second gear rack 70 is positioned on a concave surface of second door 40. Actuation assembly 44 moves first and second doors 38 and 40 via engagement with first and second gear racks 68 and 70 within grooves 64 of respective first and second frames 46 and 48 to control airflow through first opening 58 and second opening 60, respectively.

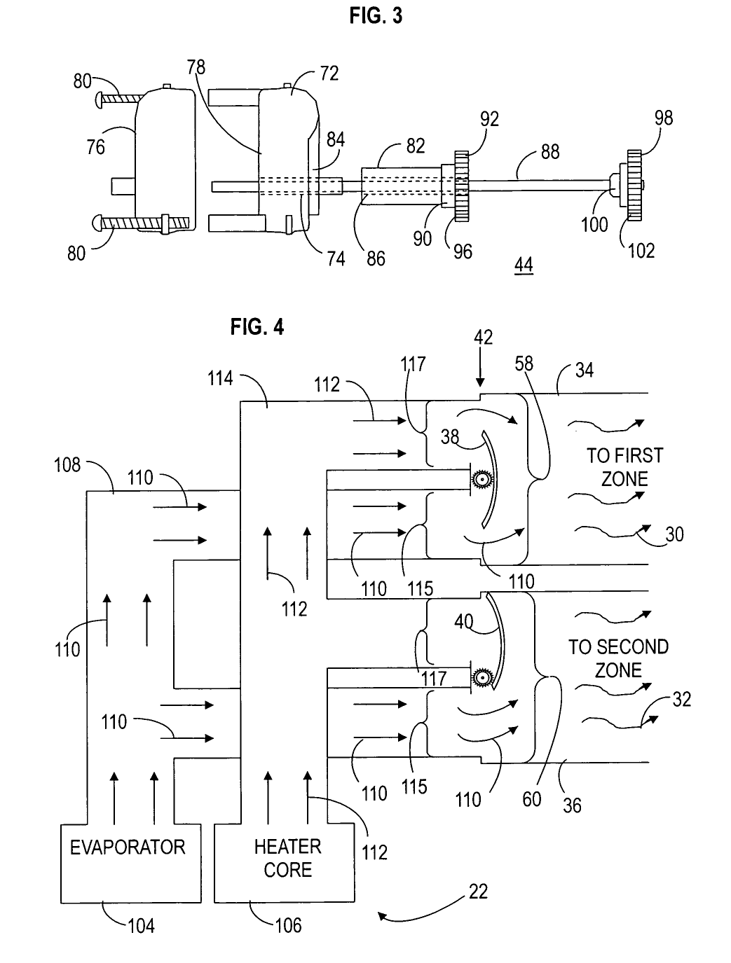

Referring to FIG. 3 in connection with FIG. 2, FIG. 3 shows an exploded side view of actuation system 44 of door assembly 42. Actuation system 44 includes a first motor actuator 72 having a first interior passage 74. A second motor actuator 76 is arranged in line with first actuator 72 and is positioned on a first side 78 of first actuator 72. Fasteners 80 couple first actuator 72 in abutment with second actuator 76.

A first shaft 82 extends from a second side 84 of first actuator 72, second side 84 opposing first side 78. First shaft 82 includes a second interior passage 86. A second shaft 88 extends from second actuator 76. Second shaft 88 is directed through first and second interior passages 74 and 86 and exits from an end 90 of first shaft 82 and is rotatable within first and second interior passages 74 and 86.

A first gear 92 is coupled to free end 90 of first shaft 82. First gear 92 has gear teeth 96 configured for meshed engagement with first gear rack 68 of first door 38. Similarly, a second gear 98 is coupled to a second free end 100 of second shaft 88 extending from free end 90 of first shaft 76. Second gear 98 has gear teeth 102 configured for meshed engagement with second gear rack 70 of second door 40.

First actuator 72 drives, i.e., rotates, first shaft 82 to cause movement of first door 38 via the meshed engagement of gear teeth 96 of first gear 92 with first gear rack 68. Similarly, second actuator 76 drives, i.e., rotates, second shaft 88 to cause movement of second door 40 via the meshed engagement of gear teeth 102 of second gear 98 with second gear rack 70. Moreover, second shaft 88 rotates independent from first shaft 82 within first and second interior passages 74 and 86, respectively. Thus, movement of second door 40 is independent of the movement of first door 38.

In a preferred embodiment, communication between first shaft 82 and first door 38 to produce door movement is accomplished through the meshed engagement of first gear 92 with first gear rack 68. Likewise, communication between second shaft 88 and second door 40 to produce door movement is accomplished through the meshed engagement of second gear 98 with second gear rack 70. Those skilled in the art will recognize, however, that alternative components may be utilized in place of the meshed gear and gear rack systems described. above.

The alignment of first and second actuators 72 and 76, respectively, with first and second shafts 82 and 88, respectively, yields a compact actuation system that can more readily fit within the limited space of a vehicle instrumentation panel. Moreover, the in line connection between actuator, shaft, gear, and gear rack enables accurate movement of first and second doors 38 and 40, respectively, without the hysteresis found in prior art actuation systems that use offset actuators and link mechanisms.

FIG. 4 shows a block diagram of a portion of HVAC system 22 demonstrating airflow via door assembly 42 to each of first zone 26 and second zone 28 within vehicle 20. The block diagram of FIG. 4 is not a representation of the structure of first and second doors 38 and 40 within door assembly 42. Rather, demonstration of airflow in FIG. 4 is provided to clarify the function of actuation system 44 (FIG. 2) . As simplistically shown, HVAC system 22 includes an evaporator 104 and a heater core 106. Only evaporator 104 and heater core 106 are mentioned herein in order to appreciate the present invention. However, those skilled in the art will recognize that many other components make up the totality of HVAC system 22.

Evaporator 104 produces cooled air when engaged and ambient air when disengaged. The air output from evaporator 104 is transferred from evaporator 104 via a cold air supply duct 108. The air in cold air supply duct 108 will be referred to herein as a cool airflow 110 to distinguish it from a hot airflow 112 transferred from heater core 106 via a hot air supply duct 114. Cold air supply duct 108 branches to a cold air inlet 115 for each of first and second doors 38 and 40, respectively, of each door assembly 42. Hot air supply duct 114 also branches to a hot air inlet 117 for each of first and second doors 38 and 40, respectively, of each door assembly 42.

Each of first and second doors 38 and 40 move to block cool airflow 110 transferred from evaporator 104 or hot airflow 112 transferred from heater core 106 into their associated first and second zone ducts 32 and 36, respectively. Each of first and second doors 38 and 40, in certain positions, may additionally allow both cool airflow 110 and hot airflow 112 into their associated first and second zone ducts 32 and 36. Thus, appropriate adjustment of first and second doors 38 and 40 produces only cool airflow 110, only hot airflow 112, or a blended airflow in accordance with a desired temperature setting.

By way of example, first door 38 is adjusted to a position in both which cold and hot air inlets 115 and 117, respectively, are partially open. Consequently, both cool airflow 110 and hot airflow 112 enter first zone duct 32 through first opening 58 to produce airflow 30 at an intermediate temperature. However, second door 40 is adjusted to a position in which hot air inlet 117 is fully blocked. Thus, only cool airflow 110 is allowed to enter second zone duct 36 through second opening 60 to produce second airflow 32 at a maximally cool temperature.

The above discussion concentrates on the use of actuation system 44 with door assembly 42 in a dual-zone climate control system. However, the present invention may be readily adapted for use in a tri-zone or a quad-zone vehicular climate control configuration, discussed below, while achieving the benefits of simplicity of design, accurate door movement, and compact size.

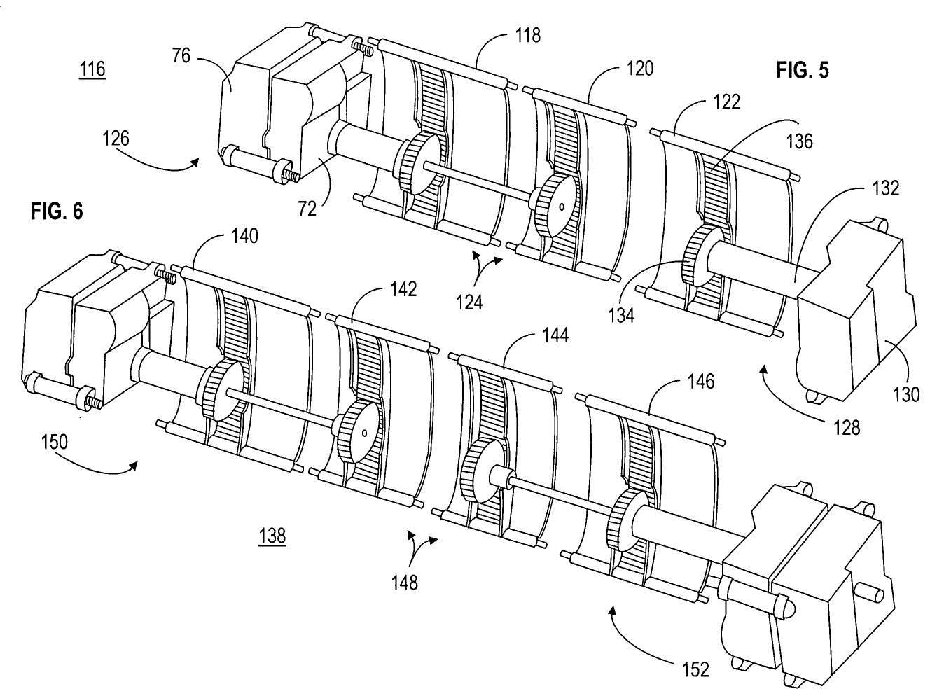

FIG. 5 shows a perspective view of a door assembly 116 for a tri-zone air handling system (not shown) in accordance with an alternative embodiment of the present invention. Door assembly 116 includes aligned ones of a first door 118, a second door 120, and a third door 122. An actuation system 124 of door assembly 116 includes a first actuation subsystem 126 and a second actuation subsystem 128. First actuation subsystem 126 moves first and second doors 118 and 120, respectively, to control airflow through their corresponding openings. As such, the description of actuation system 44 applies equally to first actuation subsystem 126, and common references numbers are used herein for components that are common to both actuation system 44 and first actuation subsystem 126.

Second actuation subsystem 128 includes a third actuator 130 arranged in line with and longitudinally displaced from first and second actuators 72 and 76 of first actuation subsystem 126. A third shaft 132 extends from third actuator 130. A third gear 134 is coupled to an end of third shaft 132 and is configured for meshed engagement with a third gear rack 136 on a concave surface of third door 122. Third actuator 130 drives, i.e., rotates, third shaft 132 to control movement of third door 122.

FIG. 6 shows a perspective view of a door assembly 138 for a quad-zone air handling system (not shown) in accordance with another alternative embodiment of the present invention. Door assembly 138 includes aligned ones of a first door 140, a second door 142, a third door 144, and a fourth door 146, each of which controls airflow through their corresponding opening. An actuation system 148 of door assembly 138 includes a first actuation subsystem 150 and a second actuation subsystem 152 longitudinally displaced from first actuation subsystem 150. First actuation subsystem 150 moves first and second doors 140 and 142, respectively, and is substantially equivalent to actuation system 44. Second actuation subsystem 152 moves third and fourth doors 144 and 146, respectively, and is also substantially equivalent to actuation system 44. However, second actuation subsystem 152 is in a mirrored orientation relative to first actuation subsystem 150 to maintain alignment of first, second, third, and fourth doors 140, 142, 144, and 146, respectively. First and second actuation subsystem 150 and 152 are configured to move first, second, third, and fourth doors 140, 142, 144, and 146 independent from one another, as described above in connection with actuation system 44.

In summary, the present invention teaches of an actuation system for controlling the movement of two or more doors in an air handling system to distribute separate temperature airstreams to multiple zones within a vehicle. The alignment of dual actuators and shafts yields a simple and compact design that efficiently utilizes the limited physical space in the vehicle. Moreover, the alignment of dual actuators and shafts eliminates the need for more complex linkage actuation that leads to inaccuracies and hysteresis in door movement. Thus, the actuation system produces accurate and timely movement of at least two doors in a multi-zone climate control system to achieve the desired cooled air, heated air, or a blend of heated and cooled air in each of the zones. In addition, the straightforward design of the actuation system can be readily and cost effectively replicated in other multi-zone applications, such as tri-zone and quad-zone.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A system for independently controlling a first door and a second door comprising:
a first actuator having a first interior passage;
a second actuator arranged in line with said first actuator;
a first shaft extending from said first actuator and having a second interior passage, said first shaft being configured for communication with said first door, and said first actuator driving said first shaft to cause movement of said first door; and
a second shaft extending from said second actuator and being directed through said first and second interior passages to exit from an end of said first shaft, said second shaft being configured for communication with said second door, and said second actuator driving said second shaft to cause movement of said second door.

2. A system as claimed in claim 1 wherein said second shaft is rotatable within said first and second interior passages.

3. A system as claimed in claim 1 wherein said second actuator is positioned on a first side of said first actuator and said first shaft extends from said first actuator on a second side of said first actuator, said second side opposing said first side.

4. A system as claimed in claim 1 further comprising fasteners coupling said first actuator in abutment with said second actuator.

5. A system as claimed in claim 1 further comprising a gear coupled to said first shaft, said gear having gear teeth configured for meshed engagement with a gear rack of said first door.

6. A system as claimed in claim 5 further comprising a second gear coupled to a said second shaft, and said second gear having second gear teeth configured for meshed engagement with a second gear rack of said second door.

7. A system as claimed in claim 1 further comprising a gear coupled to a free end of said second shaft, said free end extending from said end of said first shaft, and said second gear having gear teeth configured for meshed engagement with a gear rack of said second door.

8. A system as claimed in claim 1 wherein said second shaft rotates independent from said first shaft to cause said movement of said second door independent of said movement of said first door.

9. A system as claimed in claim 1 wherein:
said first shaft moves said first door to control airflow through a first opening in a heating, ventilation, and air conditioning (HVAC) system in a vehicle; and
said second shaft moves said second door to control said airflow through a second opening in said HVAC system.

10. A system as claimed in claim 1 wherein said system further controls a third door, and said system further comprises:
a third actuator arranged in line with and longitudinally displaced from said first and second actuators; and
a third shaft extending from said third actuator, said third shaft being configured for communication with said third door, said third actuator driving said third shaft to cause movement of said third door.

11. A system as claimed in claim 10 wherein said system further controls a fourth door, said third actuator has a third interior passage, said third shaft has a fourth interior passage, and said system further comprises:
a fourth actuator arranged in line with said third actuator; and
a fourth shaft extending from said fourth actuator and being directed through said third and fourth interior passages to exit from a second end of said third shaft, said fourth shaft being configured for communication with a fourth door, and said fourth actuator driving said fourth shaft to cause movement of said fourth door.

12. A system for independently controlling a first door and a second door comprising:
a first actuator having a first interior passage;
a second actuator arranged in line with said first actuator and positioned on a first side of said first actuator;
a first shaft extending from a second side of said first actuator, said second side opposing said first side, and having a second interior passage, said first shaft being configured for communication with said first door, and said first actuator driving said first shaft to cause movement of said first door; and
a second shaft extending from said second actuator and being directed through said first and second interior passages to exit from an end of said first shaft, said second shaft being rotatable within said first and second interior passages, said second shaft being configured for communication with said second door, and said second actuator driving said second shaft to cause movement of said second door.

13. A system as claimed in claim 12 further comprising a gear coupled to said first shaft, said gear having gear teeth configured for meshed engagement with a gear rack of said first door.

14. A system as claimed in claim 12 further comprising a gear coupled to said second shaft, said second gear having gear teeth configured for meshed engagement with a gear rack of said second door.

15. A door assembly for use in a heating, ventilation, and air conditioning (HVAC) system comprising:
a first door for controlling airflow through a first opening of said HVAC system depending on a position of said first door;
a second door for controlling airflow through a second opening of said HVAC system depending on a position of said second door; and
an actuation system for controlling movement of said first and second doors, said actuation system including:
a first actuator having a first interior passage;
a second actuator arranged in line with said first actuator;
a first shaft extending from said first actuator and being in communication with said first door, said first shaft having a second interior passage, and said first actuator driving said first shaft to move said first door to control said airflow through said first opening; and
a second shaft extending from said second actuator and being directed through said first and second interior passages to exit from an end of said first shaft, said second shaft rotating independent from said first shaft, said second shaft being in communication with said second door, and said second actuator driving said second shaft to move said second door to control said airflow through said second opening.

16. A door assembly as claimed in claim 15 wherein said second shaft is rotatable within said first and second interior passages.

17. A door assembly as claimed in claim 15 wherein
said first door includes a gear rack; and
said actuation system further comprises a gear coupled to said first shaft, said gear having gear teeth for meshed engagement with said gear rack of said first door.

18. A door assembly as claimed in claim 17 wherein:
said second door includes a second gear rack; and
said actuation system further comprises a second gear coupled to said second shaft, and said second gear having second gear teeth for meshed engagement with said second gear rack of said second door.

19. A door assembly as claimed in claim 15 further comprising:
a third door for controlling airflow through a third opening of said HVAC system depending on a position of said third door; and
said actuation system further includes:
a third actuator arranged in line with and longitudinally displaced from said first and second actuators; and
a third shaft extending from said third actuator, said third shaft being configured for communication with said third door, said third actuator driving said third shaft to move said third door to control said airflow through said third opening.

20. A door assembly as claimed in claim 19 further comprising:
a fourth door for controlling airflow through a fourth opening of said HVAC system depending on a position of said fourth door; and
said actuation system further includes:
a fourth actuator arranged in line with said third actuator; and
a fourth shaft extending from said fourth actuator and being directed through said third and fourth interior passages to exit from a second end of said third shaft, said fourth shaft being configured for communication with a fourth door, and said fourth actuator driving said fourth shaft to cause movement of said fourth door.
